(19) United States
(12) Patent Application Publication
(10) Pub. No.: US 2026/0006630 A1
(43) Pub. Date: Jan. 1, 2026

(54) ENERGY EFFICIENT ALLOCATION OF NON-TERRESTRIAL NETWORK RESOURCES FOR TERRESTRIAL USER EQUIPMENT

(71) Applicant: T-Mobile USA, Inc., Bellevue, WA (US)

(72) Inventors: Kun Lu, Bellevue, WA (US); Karri M. Kuoppamaki, Kirkland, WA (US); Jun Liu, Sammamish, WA (US); George Frantz Cummings, Gilbert, AZ (US); Egil Gronstad, Bellevue, WA (US); Brian A. Olsen, Kirkland, WA (US)

(21) Appl. No.: 18/757,316

(22) Filed: Jun. 27, 2024

(51) Int. Cl. H04W 72/51; H04W 72/12; H04W 72/563; H04W 84/06

(52) U.S. Cl. CPC H04W 72/51; H04W 72/12; H04W 72/563; H04W 84/06

(57) ABSTRACT

Systems and methods comprising instructions to detect real-time spatial distances between a satellite of a non-terrestrial network (NTN) and multiple wireless devices subscribed to a telecommunications network, determine, based a real-time spatial distance between each wireless device and the satellite, an estimated utilization of one or more resources of the satellite by the wireless device to access the telecommunications network via the satellite, prioritize a first subset of the multiple wireless devices having a lower estimated utilization of the one or more resources over a second subset of the multiple wireless devices having a higher estimated utilization of the one or more resources, and cause biased allocation of the one or more resources for prioritizing communications of the first subset of the multiple wireless devices to the telecommunications network via the satellite over the second subset of the multiple wireless devices.

### BACKGROUND

Non-terrestrial networks (NTNs) are wireless communication systems that operate above the Earth's surface, involving satellites at low Earth orbit (LEO), medium Earth orbit (MEO), and geostationary Earth orbit (GEO), high-altitude platforms (HAPS), and drones. Such components are essential to realizing seamless coverage, bringing coverage even to remote areas that do not have access to traditional terrestrial networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIGS. 2A-2B are block diagrams that illustrate components of a resource allocation system in some implementations.

FIG. 3 is a flow diagram that illustrates a process to configure a resource allocation system in some implementations.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed herein are systems and related methods for dynamically managing allocation of non-terrestrial network (NTN) resources for connected user equipment (UE) devices of varying geographic locations within the NTN coverage area. The disclosed system evaluates the spatial environment between the covered UE devices and the NTN to determine a power-optimized strategy for distributing available NTN resources to prioritized UE devices.

The disclosed system can assign a resource allocation priority to each UE device within an NTN coverage area based on immediate spatial conditions of the UE device. For example, the disclosed system can assign higher resource allocation priority to select UE devices within the NTN coverage area with shorter geolocation distances from the NTN. Similarly, the disclosed system can assign a lower resource allocation priority to select UE devices within the NTN coverage area with longer geolocation distances from the NTN. Based on the assigned resource allocation priorities, the disclosed system can distribute finite resources (e.g., electrical power at the NTN) for connecting the NTN to the UE devices within the NTN coverage area, where resources for connecting to UE devices with higher resource allocation priorities are allocated prior and/or in greater quantities to UE devices with lower resource allocation priorities. Additionally, the disclosed system can actively monitor changes to spatial conditions (e.g., distance from the NTN) of each UE device within the NTN coverage area. Upon identifying a change in the spatial condition for a UE device, the system can dynamically adjust the resource allocation priority for the UE device.

In contrast, existing systems typically use a spatial agnostic method of distributing finite available resources for maintaining communications between an NTN and UE devices, which can often result in inefficient power consumption with respect to the total number of UE devices served within the NTN covered area. For example, a common resource allocation strategy of existing systems is to distribute the finite resources of an NTN such that the data transfer rate between the NTN and UE devices within a coverage area is approximately the same across all UE devices. However, UE devices that have greater spatial distances from the NTN generally require greater amounts of power consumption at the NTN to maintain the same data transfer rate. In these situations, existing systems often schedule the allocation of finite resources (e.g., available NTN electrical power) for connecting to the UE devices in a random manner, which can result in resource allocation for UE devices with greater power consumption requirements before UE devices with less power consumption requirements. Since the finite available NTN resources are often insufficient to fulfill the power consumption requirements of every UE device within the coverage area, allocating resources for UE devices with greater power consumption requirements before UE devices with less power consumption requirements can lead to faster depletion of available NTN resources for distribution. As a result, these and other problems can significantly reduce the total number of UE devices for which the NTN can allocate sufficient resources, which can negatively impact telecommunication service providers, subscribers, third-party services, and so forth.

Accordingly, there is a need for technologies that overcome the foregoing problems and provide additional benefits. For example, there is a need for a system that can determine a resource allocation priority for each UE device based on spatial conditions with respect to an NTN and subsequently schedule resource allocation for UE devices with greater resource allocation priorities before UE devices with lower resource allocation priorities. Additionally, there is a need for a real-time system that can actively monitor changes to spatial conditions of the UE devices within the NTN coverage area and update the resource allocation priority for the UE devices.

Advantages of the disclosed technology include maximizing the total number of UE device connections that are supported by the finite available NTN resources, such as by prioritizing resource allocation for UE devices with shorter geographic distances from the NTN. As a result, the disclosed technology can generate an efficient allocation schedule for the finite NTN resources by prioritizing UE device connections with lower power requirements, and thus minimizing the overall NTN power consumption per UE device connection. Furthermore, the disclosed technology can intelligently adjust resource allocation priorities for the UE devices in real time as spatial conditions of the UE devices with respect to the NTN continuously change, which enables the system to consistently generate an efficient resource allocation schedule.

For illustrative purposes, examples are described herein in the context of NTNs. However, a person skilled in the art will appreciate that the disclosed system can be applied in other contexts. For example, the disclosed system can be used to manage allocation of resources from other telecommunication services, such as air-to-ground (ATG) networks, for connecting UE devices of varying geographic locations within a coverage area.

The operation to prioritize NTN resource allocation for UE device connections with lower power consumption requirements causes a reduction in greenhouse gas emissions compared to conventional methods of random resource allocation scheduling. Every year, approximately 40 billion tons of carbon dioxide (CO₂) are emitted around the world. Power consumption by digital technologies including telecommunications networks accounts for approximately 4% of this figure. Further, randomly allocating resources for UE devices with greater power consumption can exacerbate the causes of climate change. For example, the average U.S. power plant expends approximately 600 grams of carbon dioxide for every kWh generated. The implementations disclosed herein for generating an efficient allocation schedule for the finite NTN resources can mitigate climate change by reducing and/or preventing additional greenhouse gas emissions into the atmosphere. For example, prioritizing UE device connections with lower power requirements as described herein significantly reduces electrical power consumed by an NTN for each UE device connection as compared to traditional methods.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

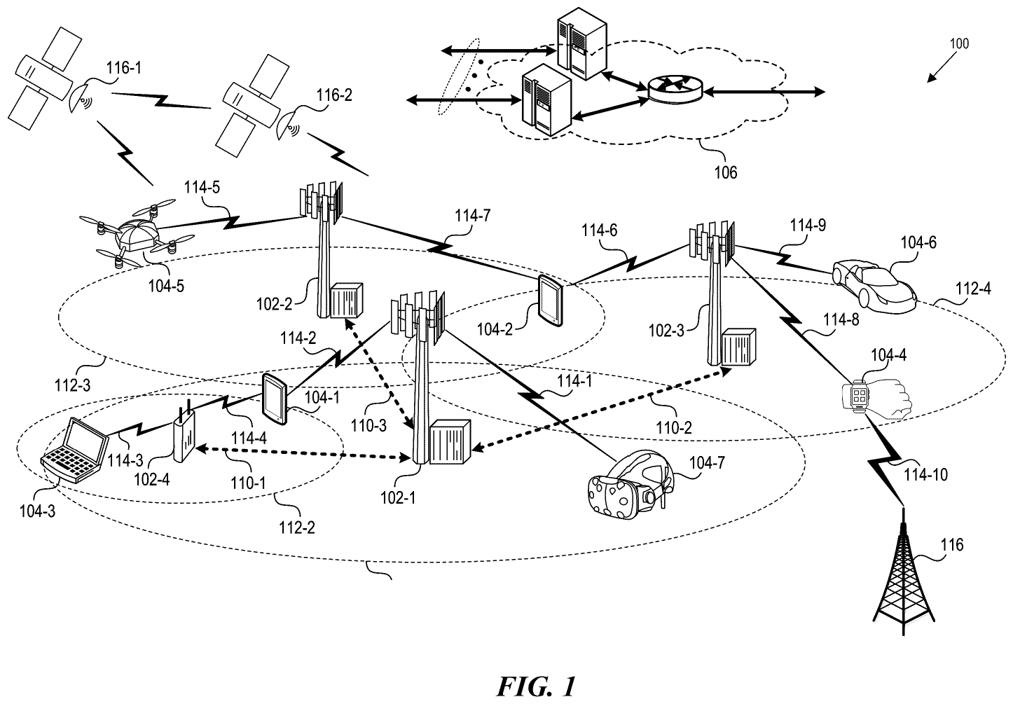

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X2 or Xn interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Resource Allocation System

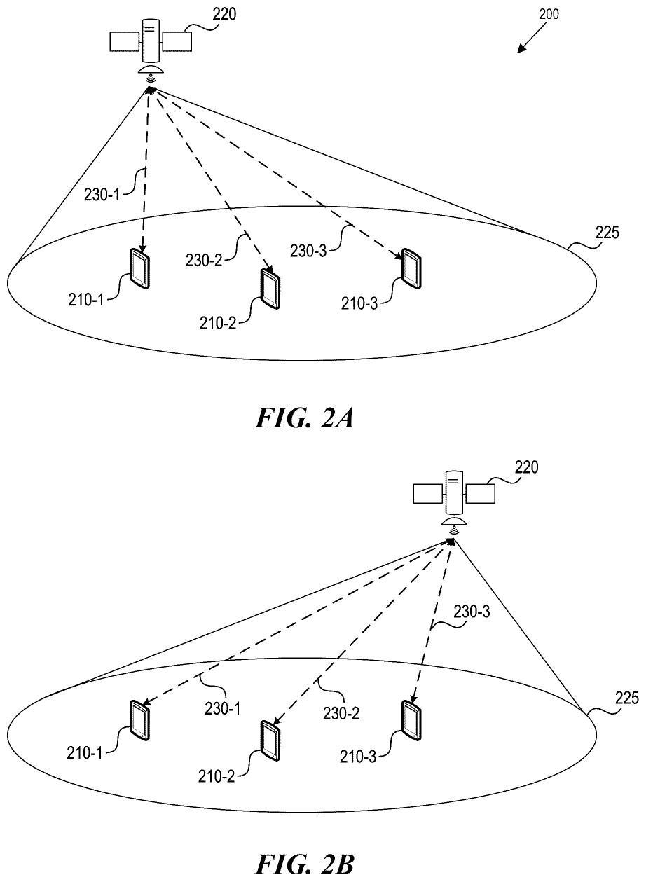

FIGS. 2A-2B are block diagrams that illustrate components of a resource allocation system 200 in some implementations. The system 200 includes wireless devices 210-1 through 210-3 (also referred to individually as “wireless device 210” or collectively as “wireless devices 210”) and a local NTN 220, which are discussed in further detail below. All or portions of system 200 can be provided, for example, by a telecommunications service that provides all or portions of system 200 using one or more components of the network 100.

As shown in FIGS. 2A-2B, wireless devices 210 (e.g., mobile user equipment devices) within a network coverage area 225 of a local NTN 220 (e.g., roaming LEO satellites) can establish network connections 230-1 through 230-3 (also referred to individually as “network connection 230” or collectively as “network connections 230”) with the local NTN 220 for communicating information (e.g., transmitting telecommunications data) between the wireless devices 210 and the NTN 220.

In some embodiments, a local NTN 220 can be configured as an Earth fixed cell (EFC), or a quasi-EFC, where the NTN 220 can readjust beam steering direction of the satellite (e.g., antennae steering) to dynamically correct for the satellite motion and maintain static coverage over a network coverage area 225 (e.g., same geographic region) for a finite time duration. In other embodiments, a local NTN 220 can be configured as an Earth moving cell (EMC) that orbits the Earth at an angular speed different from the rotational speed of the Earth. In contrast to EFC-configured satellites, EMC-configured satellites continuously orbit past a network coverage area 225, resulting in EMC satellites eventually arriving at an orbital location that obscures direct (e.g., exposed) view of the target network coverage area 225. As a result, EMC-configured satellites can only service the same network coverage area 225 for a limited duration throughout a single day. For clarity, a local NTN 220 configured as an EMC satellite is depicted in FIGS. 2A-2B. However, the following systems and methods discussed herein are similarly applicable to a local NTN 220 configured as an EFC satellite. In additional or alternative embodiments, the local NTN 220 can be configured as a GEO satellite that can follow a geosynchronous orbit, enabling the NTN 220 satellite to remain above a network coverage area 225 of the Earth's surface (e.g., same geographic region) at a steady altitude for an indefinite time duration.

In other embodiments, the local NTN 220 can be a transparent remote network access node configured to act as a remote signal relay (e.g., an analog frequency repeater, a multi-frequency transmitter, and/or the like) to extend transmission of radio signals between NTN gateways connected to ground-based network nodes (e.g., gNB). In additional or alternative embodiments, the local NTN 220 can be a non-transparent, or regenerative, remote network access node configured to perform functionalities of traditional ground-based network access nodes (e.g., hosting gNB functions). Network operations performed by regenerative network access nodes (e.g., signal regeneration, facilitating connection to wireless devices, signal enhancement) often consume significantly more power than network operations performed by a transparent network access node (e.g., repeating radio signals without modifications). With respect to ground-based network access nodes, base stations (e.g., gNB) are often directly connected (e.g., wired) to a steady power generation source nearby, and thus economic power allocation is not a significant concern. In contrast, remote NTN 220 satellites lack such constant energy sources and are thus limited to regenerative power sources, such as solar energy. To compound the issue, NTN 220 satellites have limited energy storage capacities that will need to be recharged once depleted.

To optimize power consumption in the process of servicing wireless devices 210 within the network coverage area 225 of the regenerative NTN network, the system 200 can employ systems and methods described herein to maximize the number of wireless devices 210 served with respect to limited satellite resources (e.g., regenerative solar power). The systems and/or methods can be implemented with a combination of software (e.g., executable instructions or computer code) and hardware (e.g., one or more memories and one or more processors) of the system 200. Accordingly, as used herein, in some examples, the system 200 represents a computing device having one or more processors that are at least temporarily configured and/or programmed by executable instructions carried in one or more memories to perform one or more of the functions described herein. For clarity, the following discussion with respect to the systems and methods disclosed herein are exemplified and expanded upon with respect to a regenerative NTN 220 satellite. However, the following systems and methods disclosed herein are applicable to transparent NTN 220 satellites and/or ground-based network access nodes that may lack a constant power source.

In some embodiments, the system 200 can operate the local NTN 220 to determine one or more spatial conditions of each wireless device 210 within a network coverage area 225 serviced by the NTN 220. In one aspect, the local NTN 220 can identify a relative geolocation (e.g., with respect to the NTN 220) of a connected wireless device 210 within the network coverage area 225 to calculate an approximate distance between the connected wireless device 210 and a current location of the NTN 220. In particular, the local NTN 220 can approximate the distance as a combination of a horizontal displacement (e.g., tangential to Earth's surface) and a vertical displacement from the geolocation of the connected wireless device 210 to the current location of the NTN 220. As an illustrative example, a local NTN 220 roaming over a network coverage area 225 at a steady vertical height (e.g., ˜600 kilometers (km) vertical) can determine a first distance measure to a first wireless device 210-1 that is directly below (e.g., ˜0 km horizontal) the NTN 220 and a second distance measure to a second wireless device 210-2 that has a horizontal displacement (e.g., ˜100 km horizontal) such that the first distance measure (˜600 km) is shorter than the second distance measure (˜608 km), as depicted in FIG. 2A.

In other aspects, the local NTN 220 can determine the relative geolocation of the connected wireless device 210 within the network coverage area 225 to calculate an approximate angle between the connected wireless device 210 and the current location of the NTN 220. As an illustrative example, the local NTN 220 can determine a first angle measure for the first wireless device 210-1 and a second angle measure for the second wireless device 210-2 such that the first angle measure (e.g., ˜0 degrees) is less than the second angle measure (˜80 degrees). Accordingly, the determined angle measure for a wireless device 210 correlates with the determined distance for the wireless device 210. In other words, the local NTN 220 can be configured to determine a distance measure, an angle measure, or both as representative proxies for evaluating severity of misalignment between geolocations of connected wireless devices 210 and the geolocation directly beneath the NTN 220 satellite.

In some embodiments, the system 200 can configure the local NTN 220 to capture updated spatial conditions (e.g., spatial distances and/or angles) for each wireless device 210 within a network coverage area 225 at periodic time intervals (e.g., real time). In particular, the local NTN 220 can update previously determined spatial conditions for a connected wireless device 210 by calculating an updated distance measure and/or an updated angle between an updated current location of the NTN 220 and an updated relative geolocation of the connected wireless device 210. Accordingly, the local NTN 220 can frequently generate (e.g., in real time) up-to-date spatial condition information for each wireless device 210 within the network coverage area 225 of the NTN 220. As an illustrative example, the local NTN 220 can determine an initial set of spatial conditions for wireless devices 210-1, 210-2, 210-3 with established network connections 230-1, 230-2, 230-3 to the NTN 220 based on an initial set of relative geolocations for the wireless devices 210-1, 210-2, 210-3 captured at a first time period, as depicted in FIG. 2A. Subsequently, the local NTN 220 can update the set of spatial conditions based on an updated set of relative geolocations for the wireless devices 210-1, 210-2, 210-3 captured at a second time period (e.g., after first time period), as depicted in FIG. 2B.

In some embodiments, the system 200 can configure a local NTN 220 to determine a service prioritization order for wireless devices 210 of a network coverage area 225 based on relative power consumption for servicing the wireless devices 210. For example, the local NTN 220 can approximate a minimum required resource allocation (e.g., minimum required power utilization) for maintaining and/or servicing (e.g., communicating telecommunications data) a connected wireless device 210 within the network coverage area 225. In particular, the local NTN 220 can determine the minimum required resource allocation for a connected wireless device 210 as the total amount of satellite resources (e.g., solar power cells, physical resource blocks (PRBs), modulation and coding schemes (MCSs), etc.) used by the NTN 220 to transmit a fixed amount of data within a specified unit of time (e.g., data transfer rate). Accordingly, the NTN 220 can assign a relative priority for a wireless device 210, or a set of wireless devices 210, based on the approximated minimum required resource allocation for the wireless device 210. In particular, the NTN 220 can assign a wireless device 210 with a smaller minimum required resource allocation with a higher relative priority (e.g., higher placement in the service prioritization order). In some embodiments, the local NTN 220 can be configured to prioritize a wireless device 210 with an already established network connection 230 to the NTN 220 over a wireless device 210 without an established network connection 230 to the NTN 220.

In additional or alternative embodiments, the local NTN 220 can use the approximated spatial conditions (e.g., distance and/or angle) of a wireless device 210 to determine an approximate minimum required resource allocation for the wireless device 210. Wireless devices 210 with relative geolocations farther (e.g., longer spatial distances) from the current location of the NTN 220 often require significantly more allocated satellite resources to achieve data transfer rates similar to data transfer rates of wireless devices 210 with geolocations closer to the current location of the NTN 220. Accordingly, the NTN 220 can associate a larger minimum required resource allocation for a wireless device 210 with a larger distance measure and/or angle measure, and vice versa. In other embodiments, the local NTN 220 can dynamically update the service prioritization order for wireless devices 210 in response to detecting an updated set of spatial conditions (e.g., spatial distance and/or angle) for the wireless devices 210. As an example, the local NTN 220 can determine new approximate minimum required resource allocations for each wireless device 210 based on the updated set of spatial conditions.

In some embodiments, the system 200 can configure the local NTN 220 to perform a bias allocation of satellite resources (e.g., solar power) to service wireless devices 210 within the network coverage area 225 based on the service prioritization order. In particular, the local NTN 220 can be configured to prioritize serving (e.g., using satellite resources to transmit telecommunications data) wireless devices 210 with a higher priority before wireless devices 210 with a lower priority in the service prioritization order. Accordingly, the local NTN 220 can be configured to serve wireless devices 210, in order, from highest to lowest priority until available satellite resources are depleted. In other words, the local NTN 220 can attempt to serve as many wireless devices 210 as possible before an inactive period for replenishing satellite resources. As such, the system 200 can dynamically generate a biased allocation schedule for allocating satellite resources according to the service prioritization order. In additional or alternative embodiments, the system 200 can dynamically adjust the biased allocation schedule based on a projected flight path (e.g., change in current location of local NTN 220) of the local NTN 220 satellite (e.g., and/or predicted variations in relative geolocations of wireless devices 210). In other embodiments, in response to an absence of recorded spatial conditions and/or approximate minimum required resource allocation for the wireless devices 210, the local NTN 220 can be configured to generate a default, random allocation schedule for evenly allocating satellite resources to wireless devices 210 (e.g., in random order) to service a constant data transfer rate.

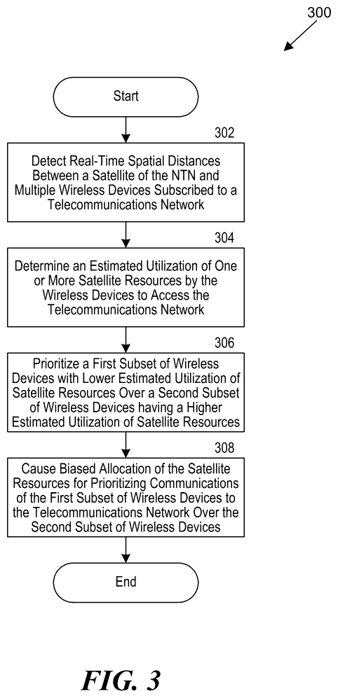

FIG. 3 is a flow diagram that illustrates a process to configure a resource allocation system in some implementations. The process 300 can be performed by a system associated with a non-terrestrial network (NTN) configured to dynamically allocate resources for prioritizing communications between select wireless devices and a telecommunications network via the NTN. In one example, the system includes at least one hardware processor and at least one non-transitory memory storing instructions, which, when executed by the at least one hardware processor, cause the system to perform the process 300. In another example, the system includes a non-transitory, computer-readable storage medium comprising instructions recorded thereon, which, when executed by at least one data processor, cause the system to perform the process 300.

At 302, the system can detect real-time spatial distances between a satellite (e.g., a network access node) of an NTN and multiple wireless devices subscribed to a telecommunications network such that the wireless devices are located terrestrially and configured to access the telecommunications network via the NTN and a terrestrial network (TN). For example, the system can receive an indication of a geolocation of each of the multiple wireless devices reported from the multiple wireless devices and determine a location and movement of the satellite in Earth's orbit. Accordingly, the system can calculate the real-time spatial distances based on the geolocations of the multiple wireless devices relative to the location and the movement of the satellite.

At 304, the system can determine an estimated utilization of one or more resources of the satellite by a wireless device to access the telecommunications network via the satellite based on a real-time spatial distance between the wireless device and the satellite. In some embodiments, the one or more resources can comprise PRBs, MCSs, a source of power including an onboard battery charged with solar energy captured at the satellite, or any combination thereof. In additional or alternative embodiments, the system can determine the estimated utilization of the one or more resources of the satellite for connecting each of the multiple wireless devices to access the telecommunications network by calculating an estimated power utilization to initiate or maintain a connection from each wireless device to the satellite based on a current geolocation of the wireless device relative to a location and movement of the satellite in Earth's orbit.

At 306, the system can prioritize a first subset of the multiple wireless devices having a lower estimated utilization of the one or more resources over a second subset of the multiple wireless devices having a higher estimated utilization of the one or more resources. In other embodiments, the system can prioritize any wireless devices that have current connections via the satellite to the telecommunications network over other wireless devices having the lower estimated utilization and allocate the one or more resources to maintain the current connections via the satellite to the telecommunications network.

At 308, the system can cause biased allocation of the one or more resources for prioritizing communications of the first subset of the multiple wireless devices to the telecommunications network via the satellite over the second subset of the multiple wireless devices. In some embodiments, the system can monitor changes to spatial conditions of each of the multiple wireless devices within a coverage area of the NTN and dynamically adjust allocation of the one or more resource for the multiple wireless devices based on the changed spatial conditions. For example, the system can cause the biased allocation of the one or more resources to occur at a first time. Afterwards, the system can detect at a second time later than the first time new spatial distances between the satellite and the multiple wireless devices subscribed to a telecommunications network such that the new spatial distances changed from previous spatial distances in response to relative movement between the satellite and the multiple wireless devices. As such, the system can reprioritize wireless devices having lower estimated utilization of the one or more resources over other wireless devices having higher estimated utilization of the one or more resources based on the new spatial distances and adjust allocation of the resources to the multiple wireless devices having the lower estimated utilization of resources.

In some embodiments, the system can dynamically adjust a schedule for allocating the one or more resources based on a flight path of the satellite. In other embodiments, the system can provision the one or more resources for the multiple wireless devices by allocating a greater portion of the one or more resources of the satellite for the first subset of the multiple wireless devices. In additional or alternative embodiments, the system can allocate the one or more resources to reduce power consumption by the satellite and by the multiple wireless devices, thereby reducing climate change mitigation by preserving power utilization.

### Computer System

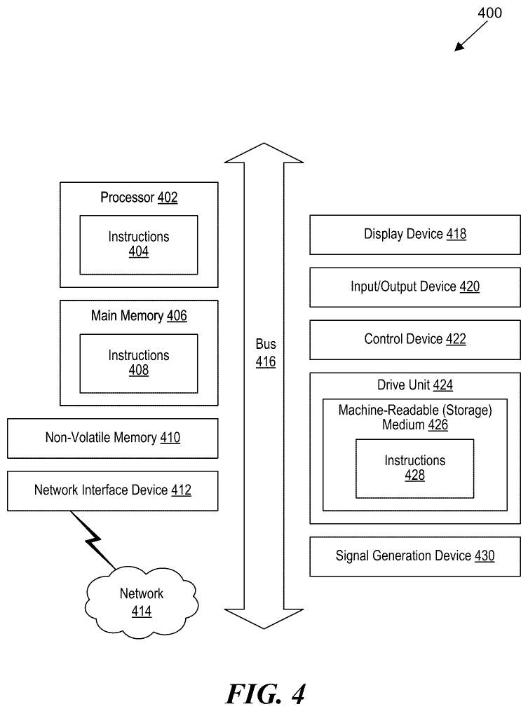

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, a video display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computer system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system associated with a non-terrestrial network (NTN), the system comprising:
at least one hardware processor; and
at least one non-transitory memory storing instructions, which, when executed by the at least one hardware processor, cause the system to:
detect real-time spatial distances between a satellite of the NTN and multiple wireless devices subscribed to a telecommunications network,
wherein the satellite is a network access node of the NTN, and
wherein the wireless devices are located terrestrially and configured to access the telecommunications network via the NTN and a terrestrial network (TN);
determine, based on a real-time spatial distance between each wireless device and the satellite, an estimated utilization of one or more resources of the satellite by the wireless device to access the telecommunications network via the satellite;
prioritize a first subset of the multiple wireless devices having a lower estimated utilization of the one or more resources over a second subset of the multiple wireless devices having a higher estimated utilization of the one or more resources; and
cause biased allocation of the one or more resources for prioritizing communications of the first subset of the multiple wireless devices to the telecommunications network via the satellite over the second subset of the multiple wireless devices.

2. The system of claim 1, wherein to cause biased allocation comprises causing the system to:
dynamically adjust a schedule for allocating the one or more resources based on a flight path of the satellite.

3. The system of claim 1, wherein the one or more resources comprise:
physical resource blocks (PRBs),
modulation and coding schemes (MCSs), or
a source of power including an onboard battery charged with solar energy captured at the satellite.

4. The system of claim 1, wherein the biased allocation of the one or more resources occurs at a first time, the system being further caused to, at a second time later than the first time:
detect new spatial distances between the satellite and the multiple wireless devices subscribed to a telecommunications network,
wherein the new spatial distances changed from previous spatial distances in response to relative movement between the satellite and the multiple wireless devices;
reprioritize, based on the new spatial distances, wireless devices having lower estimated utilization of the one or more resources over other wireless devices having higher estimated utilization of the one or more resources; and
adjust allocation of the resources to the multiple wireless devices having the lower estimated utilization of resources.

5. The system of claim 1 further caused to:
monitor changes to spatial conditions of each of the multiple wireless devices within a coverage area of the NTN; and
dynamically adjust allocation of the one or more resources for the multiple wireless devices based on the changed spatial conditions.

6. The system of claim 1, wherein to detect the real-time spatial distances between the satellite and the multiple wireless devices comprising:
receive an indication of a geolocation of each of the multiple wireless devices reported from the multiple wireless devices;
determine a location and movement of the satellite in Earth's orbit; and
calculate the real-time spatial distances based on the geolocations of the multiple wireless devices relative to the location and the movement of the satellite.

7. The system of claim 1, wherein to determine the estimated utilization of the one or more resources of the satellite for connecting each of the multiple wireless devices to access the telecommunications network comprises causing the system to:
calculate an estimated power utilization to initiate or maintain a connection from each wireless device to the satellite based on a current geolocation of the wireless device relative to a location and movement of the satellite in Earth's orbit.

8. The system of claim 1, wherein to prioritize the first subset of the multiple wireless devices comprises causing the system to:
prioritize any wireless devices that have current connections via the satellite to the telecommunications network over other wireless devices having the lower estimated utilization; and
allocate the one or more resources to maintain the current connections via the satellite to the telecommunications network.

9. The system of claim 1, wherein to provision the one or more resources for the multiple wireless devices comprises causing the system to:
allocate a greater portion of the one or more resources of the satellite for the first subset of the multiple wireless devices.

10. The system of claim 1, wherein to provision the one or more resources for the multiple wireless devices comprises causing the system to:
allocate the one or more resources to reduce power consumption by the satellite and by the multiple wireless devices, thereby reducing climate change mitigation by preserving power utilization.

11. A non-transitory, computer-readable storage medium comprising instructions recorded thereon, wherein the instructions, when executed by at least one data processor of a system, cause the system to:
detect real-time spatial distances between a satellite of a non-terrestrial network (NTN) and multiple wireless devices subscribed to a telecommunications network,
wherein the satellite is a network access node of the NTN, and
wherein the wireless devices are located terrestrially and configured to access the telecommunications network via the NTN and a terrestrial network (TN);
determine, based on a real-time spatial distance between each wireless device and the satellite, an estimated utilization of one or more resources of the satellite by the wireless device to access the telecommunications network via the satellite;
prioritize a first subset of the multiple wireless devices having a lower estimated utilization of the one or more resources over a second subset of the multiple wireless devices having a higher estimated utilization of the one or more resources; and
cause biased allocation of the one or more resources for prioritizing communications of the first subset of the multiple wireless devices to the telecommunications network via the satellite over the second subset of the multiple wireless devices.

12. The non-transitory, computer-readable storage medium of claim 11, wherein the biased allocation of the one or more resources occurs at a first time, the instructions further cause the system to, at a second time later than the first time:
detect new spatial distances between the satellite and the multiple wireless devices subscribed to a telecommunications network,
wherein the new spatial distances changed from previous spatial distances in response to relative movement between the satellite and the multiple wireless devices;
reprioritize, based on the new spatial distances, wireless devices having lower estimated utilization of the one or more resources over other wireless devices having higher estimated utilization of the one or more resources; and
adjust allocation of the resources to the multiple wireless devices having the lower estimated utilization of resources.

13. The non-transitory, computer-readable storage medium of claim 11, wherein to detect the real-time spatial distances between the satellite and the multiple wireless devices comprising:
receive an indication of a geolocation of each of the multiple wireless devices reported from the multiple wireless devices;
determine a location and movement of the satellite in Earth's orbit; and
calculate the real-time spatial distances based on the geolocations of the multiple wireless devices relative to the location and the movement of the satellite.

14. The non-transitory, computer-readable storage medium of claim 11, wherein to prioritize the first subset of the multiple wireless devices comprises instructions further causing the system to:
prioritize any wireless devices that have current connections via the satellite to the telecommunications network over other wireless devices having the lower estimated utilization; and
allocate the one or more resources to maintain the current connections via the satellite to the telecommunications network.

15. The non-transitory, computer-readable storage medium of claim 11, wherein to provision the one or more resources for the multiple wireless devices comprises instructions further causing the system to:
allocate a greater portion of the one or more resources of the satellite for the first subset of the multiple wireless devices.

16. A method performed by a system, the method comprising:
detecting real-time spatial distances between a satellite of a non-terrestrial network (NTN) and multiple wireless devices subscribed to a telecommunications network,
wherein the satellite is a network access node of the NTN, and
wherein the wireless devices are located terrestrially and configured to access the telecommunications network via the NTN and a terrestrial network (TN);
determining, based on a real-time spatial distance between each wireless device and the satellite, an estimated utilization of one or more resources of the satellite by the wireless device to access the telecommunications network via the satellite;
prioritizing a first subset of the multiple wireless devices having a lower estimated utilization of the one or more resources over a second subset of the multiple wireless devices having a higher estimated utilization of the one or more resources; and
causing biased allocation of the one or more resources for prioritizing communications of the first subset of the multiple wireless devices to the telecommunications network via the satellite over the second subset of the multiple wireless devices.

17. The method performed by the system of claim 16, wherein the biased allocation of the one or more resources occurs at a first time, the method further comprising, at a second time later than the first time:
detecting new spatial distances between the satellite and the multiple wireless devices subscribed to a telecommunications network,
wherein the new spatial distances changed from previous spatial distances in response to relative movement between the satellite and the multiple wireless devices;
reprioritizing, based on the new spatial distances, wireless devices having lower estimated utilization of the one or more resources over other wireless devices having higher estimated utilization of the one or more resources; and
adjusting allocation of the resources to the multiple wireless devices having the lower estimated utilization of resources.

18. The method performed by the system of claim 16, wherein detecting the real-time spatial distances between the satellite and the multiple wireless devices comprises:
receiving an indication of a geolocation of each of the multiple wireless devices reported from the multiple wireless devices;
determining a location and movement of the satellite in Earth's orbit; and
calculating the real-time spatial distances based on the geolocations of the multiple wireless devices relative to the location and the movement of the satellite.

19. The method performed by the system of claim 16, wherein prioritizing the first subset of the multiple wireless devices comprises:
prioritizing any wireless devices that have current connections via the satellite to the telecommunications network over other wireless devices having the lower estimated utilization; and
allocating the one or more resources to maintain the current connections via the satellite to the telecommunications network.

20. The method performed by the system of claim 16, wherein provisioning the one or more resources for the multiple wireless devices comprises:
allocating a greater portion of the one or more resources of the satellite for the first subset of the multiple wireless devices.
